(19) United States
(12) Patent Application Publication
(10) Pub. No.: US 2013/0278857 A1
(43) Pub. Date: Oct. 24, 2013

(54) BACKLIGHT MODULE AND LIQUID CRYSTAL DISPLAY WITH THE SAME

(71) Applicant: Dawei Zeng, Shenzhen (CN)

(72) Inventor: Dawei Zeng, Shenzhen (CN)

(73) Assignee: SHENZHEN CHINA STAR OPTELECTRONICS TECHNOLOGY CO., LTD., Shenzhen, Guangdong (CN)

(21) Appl. No.: 13/581,978

(22) PCT Filed: May 14, 2012
(86) PCT No.: PCT/CN2012/075450

§ 371 Date: Aug. 30, 2012

(30) Foreign Application Priority Data
Apr. 19, 2012 (CN) 201220171206.7

(51) Int. Cl. G02F 1/13357; F21V 8/00; F21V 29/00

(52) U.S. Cl. 349/58; 362/97.1; 362/97.3; 362/612

(57) ABSTRACT

A backlight module includes a back plate having a substrate, a heat sink substrate, and a light source. The heat sink substrate includes a heat dissipating portion and a fixing portion connected to the heat dissipating portion. The fixing portion is fixed to a lower side of the substrate. The light source is fixed on the heat dissipating portion. The present disclosure further provides a liquid crystal display with the backlight module. When the light source needs to be replaced, the heat sink substrate and the light source are disassembled without disassembling other components of the liquid crystal display, which prevents other components from being influenced by the operation of replacing the light source, simplifies the operation of the replacing the light source, and improves the yield rate of the liquid crystal display.

### BACKGROUND

1. Technical Field

The present disclosure relates to liquid crystal displaying technologies, and particularly, to a backlight module and a liquid crystal display with the same.

2. Description of Related Art

Referring to FIG. 1, generally, a liquid crystal display (LCD) 100 includes a front frame 101, a liquid crystal panel 102, a plastic frame 103, an optical film group 104, a light guide plate 105, a reflector 106, a light source 107, a heat sink substrate 108, and a back plate 109. The heat sink substrate 108 includes a heat dissipating portion and a fixing portion perpendicularly connected to the heat dissipating portion. The fixing portion is screwed to the back plate 109 via a screw. The light source 107 is mounted on an inner side of the heat dissipating portion, and includes a printed circuit board and light emitting diodes (LEDs) mounted on the printed circuit board. The reflector 106 is disposed on an inner side of the back plate 109 and the fixing portion of the heat sink substrate 108. The light guide plate 105 is disposed on the reflector 106 with the light source 107 located on one side thereof. The plastic frame 103 includes a connection portion and a supporting portion. The connection portion is fixed on an outer side of the heat sink substrate 108, and the supporting portion is located above an edge of the optical film group 104. An edge of the liquid crystal panel 102 is disposed on the supporting portion of the plastic frame 103. The front frame 101 is screwed to the plastic frame 103 and the back plate 109 via screws 111 and the edge of the liquid crystal panel 102 is sandwiched between the front frame 102 and the back plate 109.

In assembly, firstly, the light source 107 is mounted on the inner side of the heat sink substrate 108, and the heat sink substrate 108 is mounted on the back plate 109; secondly, the reflector 106, the light guide plate 105, and the optical film group 104 are disposed on the back plate 109 in order; thirdly, the plastic frame 103 is fixed to the heat sink substrate 108 and the back plate 109, and the liquid crystal panel 102 is disposed on the supporting portion of the plastic frame 103; finally, the front frame 101 is fixed to the plastic frame 103 and the back plate 109.

When the light source 107 cannot work properly and needs to be replaced, the front frame 101 is detached from the LCD 100 at first, and the liquid crystal panel 102, the plastic frame 103, the optical film group 104, the light guide plate 105, and the reflector 106 are detached in order, and then the light source 107 is allowed to be detached from the heat sink substrate 108. After the substitute light source is mounted on the heat sink substrate 108, the reflector 106, the light guide plate 105, the optical film group 104, the plastic frame 103, the liquid crystal panel 102, and the front frame 101 are re-assembled in order.

In the LCD 100, other components are disassembled and re-assembled when the light source 107 is replaced, which results in a complicated operation of replacing the light source 107, and further may influence other components and reduce the yield rate of the LCD 100.

### SUMMARY

One object of the present disclosure is to provide a backlight module. The backlight module includes a back plate having a substrate, a heat sink substrate, and a light source. The heat sink substrate includes a heat dissipating portion and a fixing portion connected to the heat dissipating portion. The fixing portion is fixed to a lower side of the substrate. The light source is fixed on the heat dissipating portion.

Preferably, the light source includes a printed circuit board and a plurality of light emitting diodes mounted on the printed circuit board, and the printed circuit board contacts the heat dissipating portion.

Preferably, a reflector is disposed on the substrate and a light guide plate is disposed on the reflector, a side of the light guide plate corresponds to the light emitting diodes of the light source, and an optical film group is disposed on the light guide plate.

Preferably, the back plate further includes a side plate substantially perpendicularly connected to the substrate and defining a first locking hole; a channel is defined at a connecting portion of the substrate and the side plate; the side plate includes a transmission portion and a first locking portion substantially perpendicularly connected to the transmission portion, the light source and the heat dissipating portion are disposed on one side of the transmission portion by passing through the channel, and the heat dissipating portion is sandwiched between the transmission portion and the light source.

Preferably, a width of the channel is greater than the total thickness of the heat dissipating portion and the light source, and a length of the channel is greater than that of the heat dissipating portion to allow the heat dissipating portion and the light source to pass therethrough.

Preferably, the first locking hole is defined in the first locking portion or the transmission portion.

Another object of the present disclosure is to provide another backlight module. The backlight module includes a back plate having a substrate, a heat sink substrate, and a light source. The heat sink substrate includes a heat dissipating portion and a fixing portion connected to the heat dissipating portion, and the fixing portion is fixed to a lower side of the substrate. The light source is disposed on the heat dissipating portion, and includes a printed circuit board contacting the heat dissipating portion and a plurality of light emitting diodes mounted on the printed circuit board.

Preferably, a fixing hole is defined in the heat dissipating portion.

Preferably, a reflector is disposed on the substrate, a light guide plate is disposed on the reflector, a side of the light guide plate corresponds to the light emitting diodes of the light source, and an optical film group is disposed on the light guide plate.

Preferably, the back plate further includes a side plate substantially perpendicularly connected to the substrate, a channel is defined at a connecting portion the substrate and the side plate; the side plate includes a transmission portion and a first locking portion substantially perpendicularly connected to the transmission portion, the light source and the heat dissipating portion are disposed on one side of the transmission portion by passing through the channel, the heat dissipating portion is sandwiched between the transmission portion and the light source; and a first locking hole is defined in the side plate.

Preferably, a width of the channel is greater than the total thickness of the heat dissipating portion and the light source, and a length of the channel is greater than that of the heat dissipating portion such that the heat dissipating portion and the light source can pass through the channel.

Preferably, the first locking hole is defined in the first locking portion or the transmission portion.

Yet another object of the present disclosure is to provide a liquid crystal display. The liquid crystal display includes a backlight module and a front frame fixed on the backlight module. The backlight module includes a back plate having a substrate, a heat sink substrate, and a light source. The heat sink substrate includes a heat dissipating portion and a fixing portion connected to the heat dissipating portion, and the fixing portion is fixed to a lower side of the substrate. The light source is disposed on the heat dissipating portion.

Preferably, the light source includes a printed circuit board and a plurality of light emitting diodes mounted on the printed circuit board; and the printed circuit board contacts the heat dissipating portion.

Preferably, the liquid crystal display further includes a plastic frame and a liquid crystal panel, the plastic frame includes a supporting portion and a holding portion substantially perpendicularly extending from a middle portion of the supporting portion, the supporting portion is disposed on a light guide plate, the holding portion is located above an optical film group, and the liquid crystal panel is disposed on the holding portion.

Preferably, the back plate further includes a side plate substantially perpendicularly connected to the substrate, a channel is defined at a connecting portion of the substrate and the side plate; the side plate includes a transmission portion and a first locking portion substantially perpendicularly connected to the transmission portion, the light source and the heat dissipating portion are disposed on one side of the transmission portion by passing through the channel, the heat dissipating portion is sandwiched between the transmission portion and the light source; a first locking hole is defined in the side plate, a second locking hole is defined in the front frame, the side plate is fixed to the front frame by inserting a screw into the first locking hole and the second locking hole.

Preferably, the front frame includes a second locking portion disposed on the first locking portion, the second locking hole is defined in the second locking portion; the first locking hole is defined in the first locking portion, the first locking portion is fixed to the second locking portion by inserting the screw into the first locking hole and the second locking hole.

Preferably, the front frame includes a side wall, the side wall and the heat dissipating portion are respectively located on two opposite sides of the transmission portion, the first locking hole is defined in the transmission portion, the second locking hole is defined in the side wall, the side plate is fixed to the transmission portion by inserting the screw into the first locking hole and the second locking hole.

Preferably, the front frame further includes a second locking portion disposed on the heat dissipating portion of the heat sink substrate, a second locking hole is defined in the second locking portion, a fixing hole is defined in the heat dissipating portion and extends downwards, a screw is capable of being inserted into the second locking hole and the fixing hole to fix the second locking portion to the heat dissipating portion.

Preferably, the front frame includes a side wall, the side wall and the light source are respectively located on two opposite sides of the transmission portion, the second locking hole is defined in the side wall, a fixing hole is defined in a side of the heat dissipating portion, a screw is capable of being inserted into the fixing hole and the second locking hole to fix the side plate to the transmission portion.

When the light source needs to be replaced, the heat sink substrate and the light source are disassembled without disassembling other components of the liquid crystal display, which prevents other components from being influenced by the operation of replacing the light source, simplifies the operation of the replacing the light source, and improves the yield rate of the liquid crystal display.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a conventional liquid crystal display;

FIG. 2 is a schematic view of a liquid crystal display in accordance with a first embodiment of the present disclosure;

FIG. 3 is a schematic view of a backlight module of the liquid crystal display of FIG. 2;

FIG. 4 is a disassembled view of the liquid crystal display of FIG. 2;

FIG. 5 is a schematic view of a liquid crystal display in accordance with a second embodiment of the present disclosure;

FIG. 6 is a disassembled view of the liquid crystal display of FIG. 5.

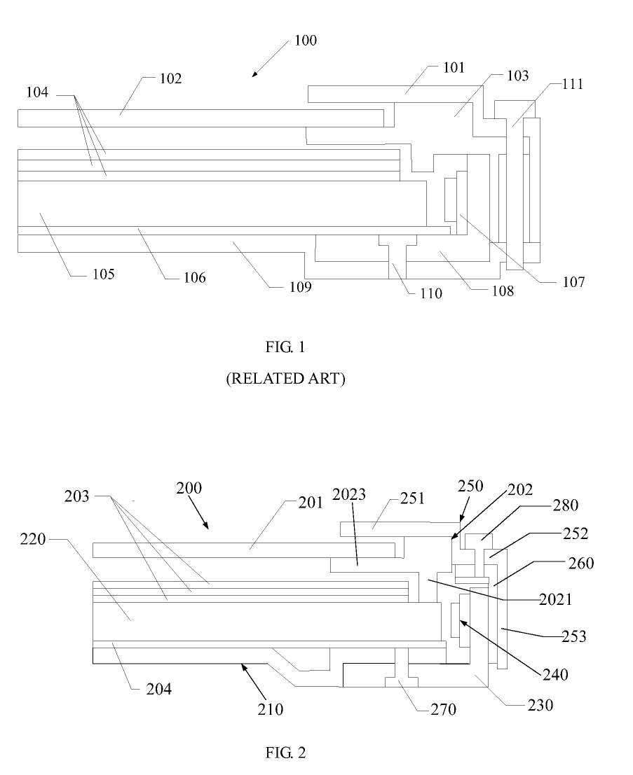

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 2, a liquid crystal display (LCD) 200, in accordance with a first embodiment of the present disclosure, is shown. The LCD 200 includes a backlight module, a plastic frame 202, a liquid crystal panel 201, and a front frame 250.

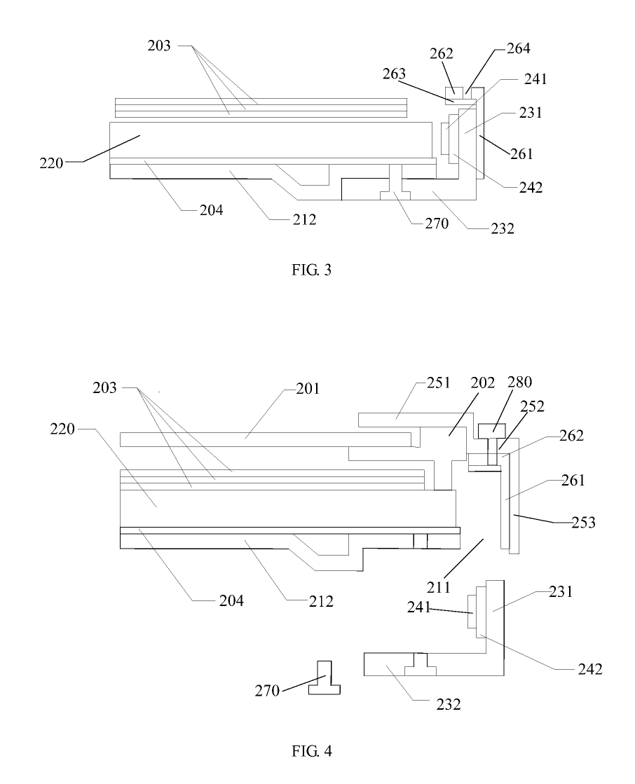

Referring to FIGS. 2 and 3, the backlight module includes a back plate 210, a heat sink substrate 230, a light source 240, a reflector 204, a light guide plate 220, and an optical film group 203. The light source 240 includes a printed circuit board (PCB) 242 and a number of light emitting diodes (LEDs) 241 mounted on the PCB 242. The heat sink substrate 230 includes a heat dissipating portion 231 and a fixing portion 232 perpendicularly connected to the heat dissipating portion 231. The light source 240 is mounted on the heat dissipating portion 231 with the printed circuit board (PCB) 242 contacting the heat dissipating portion 231.

Referring also to FIG. 4, the back plate 210 includes a substrate 212 and a side plate 260 perpendicularly connected to the substrate 212. A channel 211 is defined at a connecting portion of the substrate 212 and the side plate 260. A width of the channel 211 is greater than a total thickness of the heat dissipating portion 231 and the light source 240, and a length of the channel 211 is greater than that of the heat dissipating portion 231, such that the heat dissipating portion 231 and the light source 240 can pass through the channel 211. The fixing portion 232 is screwed to a lower side of the substrate 212 via a first screw 270. The side plate 260 includes a transmission portion 261 and a first locking portion 262 perpendicularly connected to the transmission portion 261. The transmission portion 261 corresponds to one side of the heat dissipating portion 231 which is away from the light source 240, thus, the heat dissipating portion 231 is sandwiched between the transmission portion 261 and the light source 240 after the heat dissipating portion 231 and the light source 240 are mounted onto the transmission portion 261 by passing through the channel 211. In some embodiments, the transmission portion 261 may contact the heat dissipating portion 231. The first locking portion 262 is located above the light source 240 and defines a first locking hole 264. A reflecting layer 263 is disposed on a side of the first locking portion 262 corresponding to the light source 240 for reflecting the light emitting from the light source 240 so as to improve the utilization rate of the light source 240.

The reflector 204 is disposed on the substrate 212 and is sandwiched between the reflector 204 and the light guide plate 220. One side of the light guide plate 220 corresponds to the LEDs 241 of the light source 240 to allow the light from the LEDs 241 to enter thereinto.

It is noted that the number of the light source 240 is not limited to this embodiment. In other embodiments, the LCD 200 may include a number of the light sources 240 respectively corresponding to the side of the light guide plate 220 such that the light from the light sources 240 can enter the light guide plate 220. The optical film group 203 is disposed above one side of the light guide plate 220 which is away from the reflector 204.

Referring to FIGS. 2 to 4, the plastic frame 202 includes a supporting portion 2021 and a holding portion 2023 perpendicularly extending from the middle portion of the supporting portion 2021. The supporting portion 2021 is disposed on the side of the light guide plate 220 which is away from the reflector 204. The holding portion 2023 is located above the optical film group 203 for holding the liquid crystal panel 201.

The front frame 250 includes a clamping portion 251, a side wall 253, and a second locking portion 252. One end of the second locking portion 252 is connected to the clamping portion 251 and the other end thereof is perpendicularly connected to the side wall 253. The second locking portion 252 defines a second locking hole to allow a second screw 280 to extend therethrough and be inserted into the first locking hole 264, thereby fixing the second locking portion 252 onto the first locking portion 262 and further fixing the back plate 210 with the front frame 250. In this way, the heat dissipating portion 231 of the heat sink substrate 230 can be fixed to the front frame 250. It is noted that the first locking hole 264 and the second locking hole are not limited to this embodiment. In other embodiments, the first locking hole 264 may be defined in the transmission portion 261 and the second locking hole may be defined in the side wall 253 such that the second screw 280 can fix the side plate 260 to the front frame 250 by fixing the transmission portion 261 to the side wall 253.

One end of the clamping portion 251 which is connected to the second locking portion 252 is located on the supporting portion 2021 of the plastic frame 202, and the other end of the clamping portion 251 is located above the holding portion 2023 for engaging with the holding portion 2023 to clamp the edge of the liquid crystal panel 201. The side wall 253 corresponds to a side of the transmission portion 261 which is away from the light source 240.

In assembly, the reflector 204, the light guide plate 220, and the optical film group 203 are disposed on the substrate 212 in order, and the light source 240 is fixed on the heat dissipating portion 231 of the heating dissipating substrate 230. After that, the heat dissipating portion 231 and the light source 240 are inserted through the channel 211. The fixing portion 232 of the heat sink substrate 230 is fixed to the lower side of the substrate 212 away from the reflector 204 via the first screw 270. The plastic frame 202 is disposed on the light guide plate 220 and the edge of the liquid crystal panel 201 is mounted onto the holding portion 2023 of the plastic frame 202. The front frame 250 is then fixed to the side plate 260 via the second screw 280 for clamping the liquid crystal panel 201.

When the light source 240 cannot work properly and needs to be replaced, the first screw 270 can be unscrewed to allow the heating dissipating substrate 230 and the light source 240 to be detachable. Thus, the light source 240 can be replaced without disassembling other components of the liquid crystal display 200. Therefore, other components can be prevented from being influenced by the operation of replacing the light source 240, which simplifies the operation of replacing the light source 240 and increases the yield rate of the LCD 200.

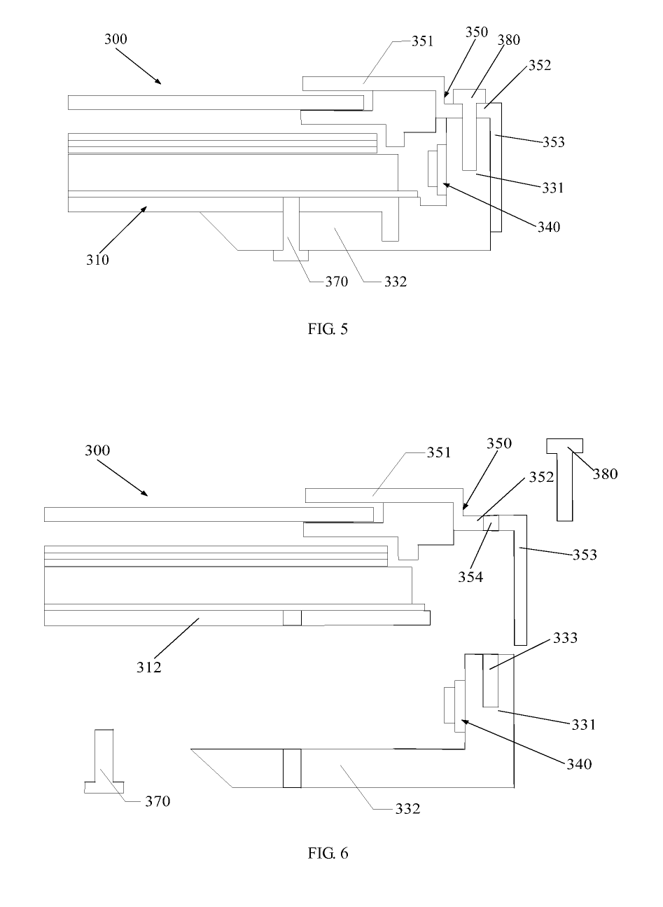

Referring to FIGS. 5 and 6, a LCD 300, in accordance with a second embodiment, is shown. The LCD 300 of the second embodiment is similar to the LCD 200 of the first embodiment, and the difference between the LCD 300 and the LCD 200 lies in that, the back plate 300 includes the substrate 312. A fixing hole 333 is defined in the heat dissipating portion 331. The second locking portion 352 of the front frame 350 is disposed on the heat dissipating portion 331. A second locking hole 354 is defined in the second locking portion 352 and corresponds to the fixing hole 333. The second screw 380 is inserted into the fixing hole 333 and the second locking hole 354 for fixing the front frame 350 to the heat dissipating portion 331. The side wall 353 of the front frame 350 contacts the side of the heat dissipating portion 331 which is away from the light source 340. In other embodiments, the fixing hole 333 may be defined in the side of the heat dissipating portion 331 which is away from the light source 340 and the second locking hole 354 may be correspondingly defined in the side wall 353.

When the light source 340 needs to be replaced, the first screw 370 and the second screw 380 are respectively unscrewed to allow the heat sink substrate 330 and the light source 340 to be detachable. Thus, the light source 340 can be replaced without disassembling other components of the LCD 300, which prevents the other components from being influenced, simplifies the operation of replacing the light source 340, and improves the yield rate of the LCD 300. Additionally, since the heat dissipating portion 331 contacts the side wall 353 directly, the heat dissipating efficiency of the heat dissipating portion 331 can be improved.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A backlight module, comprising:
a back plate having a substrate;
a heat sink substrate comprising a heat dissipating portion and a fixing portion connected to the heat dissipating portion, the fixing portion being fixed to a lower side of the substrate; and
a light source fixed on the heat dissipating portion.

2. The backlight module as claimed in claim 1, wherein the light source comprises a printed circuit board and a plurality of light emitting diodes mounted on the printed circuit board, and the printed circuit board contacts the heat dissipating portion.

3. The backlight module as claimed in claim 1, wherein a reflector is disposed on the substrate and a light guide plate is disposed on the reflector, a side of the light guide plate corresponds to the light emitting diodes of the light source, and an optical film group is disposed on the light guide plate.

4. The backlight module as claimed in claim 1, wherein the back plate further comprises a side plate substantially perpendicularly connected to the substrate and defining a first locking hole; a channel is defined at a connecting portion of the substrate and the side plate; the side plate comprises a transmission portion and a first locking portion substantially perpendicularly connected to the transmission portion, the light source and the heat dissipating portion are disposed on one side of the transmission portion by passing through the channel, and the heat dissipating portion is sandwiched between the transmission portion and the light source.

5. The backlight module as claimed in claim 4, wherein a width of the channel is greater than the total thickness of the heat dissipating portion and the light source, and a length of the channel is greater than that of the heat dissipating portion to allow the heat dissipating portion and the light source to pass therethrough.

6. The backlight module as claimed in claim 4, wherein the first locking hole is defined in the first locking portion or the transmission portion.

7. A backlight module, comprising:
a back plate having a substrate;
a heat sink substrate comprising a heat dissipating portion and a fixing portion connected to the heat dissipating portion, the fixing portion being fixed to a lower side of the substrate; and
a light source disposed on the heat dissipating portion, the light source comprising a printed circuit board contacting the heat dissipating portion and a plurality of light emitting diodes mounted on the printed circuit board.

8. The backlight module as claimed in claim 7, wherein a fixing hole is defined in the heat dissipating portion.

9. The backlight module as claimed in claim 7, wherein a reflector is disposed on the substrate, a light guide plate is disposed on the reflector, a side of the light guide plate corresponds to the light emitting diodes of the light source, and an optical film group is disposed on the light guide plate.

10. The backlight module as claimed in claim 7, wherein the back plate further comprises a side plate substantially perpendicularly connected to the substrate, a channel is defined at a connecting portion of the substrate and the side plate; the side plate comprises a transmission portion and a first locking portion substantially perpendicularly connected to the transmission portion, the light source and the heat dissipating portion are disposed on one side of the transmission portion by passing through the channel, the heat dissipating portion is sandwiched between the transmission portion and the light source; and a first locking hole is defined in the side plate.

11. The backlight module as claimed in claim 10, wherein a width of the channel is greater than the total thickness of the heat dissipating portion and the light source, and a length of the channel is greater than that of the heat dissipating portion such that the heat dissipating portion and the light source can pass through the channel.

12. The backlight module as claimed in claim 10, wherein the first locking hole is defined in the first locking portion or the transmission portion.

13. A liquid crystal display, comprising:
a backlight module, comprising:
a back plate having a substrate;
a heat sink substrate comprising a heat dissipating portion and a fixing portion connected to the heat dissipating portion, the fixing portion being fixed to a lower side of the substrate; and
a light source disposed on the heat dissipating portion; and
a front frame fixed on the backlight module.

14. The liquid crystal display as claimed in claim 13, wherein the light source comprises a printed circuit board and a plurality of light emitting diodes mounted on the printed circuit board; and the printed circuit board contacts the heat dissipating portion.

15. The liquid crystal display as claimed in claim 14 further comprising a plastic frame and a liquid crystal panel, the plastic frame comprises a supporting portion and a holding portion substantially perpendicularly extending from a middle portion of the supporting portion, the supporting portion is disposed on a light guide plate, the holding portion is located above an optical film group, and the liquid crystal panel is disposed on the holding portion.

16. The liquid crystal display as claimed in claim 13, wherein the back plate further comprises a side plate substantially perpendicularly connected to the substrate, a channel is defined at a connecting portion of the substrate and the side plate; the side plate comprises a transmission portion and a first locking portion substantially perpendicularly connected to the transmission portion, the light source and the heat dissipating portion are disposed on one side of the transmission portion by passing through the channel, the heat dissipating portion is sandwiched between the transmission portion and the light source; a first locking hole is defined in the side plate, a second locking hole is defined in the front frame, the side plate is fixed to the front frame by inserting a screw into the first locking hole and the second locking hole.

17. The liquid crystal display as claimed in claim 16, wherein the front frame comprises a second locking portion disposed on the first locking portion, the second locking hole is defined in the second locking portion; the first locking hole is defined in the first locking portion, the first locking portion is fixed to the second locking portion by inserting the screw into the first locking hole and the second locking hole.

18. The liquid crystal display as claimed in claim 16, wherein the front frame comprises a side wall, the side wall and the heat dissipating portion are respectively located on two opposite sides of the transmission portion, the first locking hole is defined in the transmission portion, the second locking hole is defined in the side wall, the side plate is fixed to the transmission portion by inserting the screw into the first locking hole and the second locking hole.

19. The liquid crystal display as claimed in claim 13, wherein the front frame further comprises a second locking portion disposed on the heat dissipating portion of the heat sink substrate, a second locking hole is defined in the second locking portion, a fixing hole is defined in the heat dissipating portion and extends downwards, a screw is capable of being inserted into the second locking hole and the fixing hole to fix the second locking portion to the heat dissipating portion.

20. The liquid crystal display as claimed in claim 13, wherein the front frame comprises a side wall, the side wall and the light source are respectively located on two opposite sides of the transmission portion, the second locking hole is defined in the side wall, a fixing hole is defined in a side of the heat dissipating portion, a screw is capable of being inserted into the fixing hole and the second locking hole to fix the side plate to the transmission portion.
